(19) United States
(12) Patent Application Publication
(10) Pub. No.: US 2007/0183368 A1
(43) Pub. Date: Aug. 9, 2007

(54) Test and debug method and apparatus

(75) Inventor: Evgeni Stavinov, Sunnyvale, CA (US)

Correspondence Address: LECROY CORPORATION, 700 CHESTNUT RIDGE ROAD, CHESTNUT RIDGE, NY, 10977, US

(73) Assignee: LECROY CORPORATION

(21) Appl. No.: 11/702,387

(22) Filed: Feb. 5, 2007

Related U.S. Application Data
(60) Provisional application No. 60/765,609, filed on Feb. 6, 2006.
(60) Provisional application No. 60/765,610, filed on Feb. 6, 2006.
(60) Provisional application No. 60/765,605, filed on Feb. 6, 2006.

(51) Int. Cl. H04Q 7/00

(52) U.S. Cl. 370/332

(57) ABSTRACT

A method for performing wireless analyzer spatial position optimization for a network having a particular network topology. The method comprises the steps of recording one or more reference network topology measurements to perform an initial parameter calibration, estimating a plurality of possible relative positions for the particular network topology, and calculating a link estimator function for each link between a plurality of the possible relative positions. Recording quality for each received packet is calculated at each of the plurality of possible relative positions over each of the links so that a position indicative of an optimal position is determined.

### CROSS-REFERENCE TO RELATED APPLICATION

This application claims the benefit under 35 USC 119(e) of US Provisional Patent Application Nos. 60/765,609, filed Feb. 6, 2006 titled Wireless Analyzer Position Optimization Algorithm; 60/765,610, filed Feb. 6, 2006, titled Programmable Pattern Match Method and Apparatus; and 60/765,605, filed Feb. 6, 2006, titled Traffic Generation Methods that Conform to Specific Statistical Distribution Patterns.

### FIELD OF THE INVENTION

This invention is related generally to the testing of Ultra-Wideband and other devices employing protocol communications and transmissions therebetween, and more particularly to a portable or other test and debug platforms that preferably combine non-intrusive recording with extensive decoding features.

### BACKGROUND OF THE INVENTION

Ultra-Wideband Technology

UWB technology has been available for over 40 years for military and civilian applications and was originally referred to as either impulse radio or carrier-free communications. More recently, the FCC definition for UWB includes any radio technology with a spectrum that occupies greater than 20 percent of the center frequency or a minimum of 500 MHz. In 2002, the FCC allocated unlicensed radio spectrum from 3.1 GHz to 10.6 GHz expressly for enterprise and consumer applications. The FCC defined a specific minimum bandwidth of 500 MHz at a −10 dB level. As current UWB implementations allow communication that requires high data rates over short distances, one immediate UWB application is WPAN (Wireless Personal Area Network).

Multi-band OFDM technology, promoted by the WiMedia Alliance, is one technology that can utilize the allocated band for UWB. The MB-OFDM transmits data simultaneously over multiple carriers spaced apart at precise frequencies. This approach provides benefits like high spectral flexibility and resiliency to RF interference and multi-path effects. These WiMedia UWB specifications are available from the WiMedia Alliance. The URL for the WiMedia website is http://www.wimedia.org

WiMedia UWB Specification Ecosystem

The WiMedia Alliance has developed specifications for ultra-wide-band (UWB) devices. The main goal of the WiMedia UWB specifications is to create a UWB “ecosystem” that allows easy and secure operation and interoperation of UWB devices. The WiMedia UWB specifications have a first-generation data rate of 480 Mbps, which enables a multitude of innovative wireless devices. UWB devices that follow the WiMedia UWB specifications can co-exist in the same physical environment, even if they have unrelated applications.

Markets for two major application types are emerging:
Certified Wireless-USB (WUSB)
WiNet

The WiMedia UWB specification first-generation data rate of 480 Mbps provides a basis for delivering WUSB devices that can perform comparably with USB 2.0 devices.

The Certified Wireless-USB protocol maintains the same host-device model as the wired

USB protocol, but the Certified Wireless-USB protocol makes many optimizations for operating efficiently on a wireless medium.

The first Certified Wireless-USB-protocol products are various Wire Adapter devices, which operate as wired-to-wireless bridges. Host Wire Adapters (HWA) enable any PC with USB 2.0 to become a WUSB Host. Device Wire Adapters (DWA) are wireless hubs that can connect wired USB 2.0 devices to a WUSB Host. The WUSB specification is available from the USB Implementers Forum (USB-IF). The URL for the USB-IF website is: http ://www.usb.org/home

WiNet is a protocol that uses the services of the WiMedia MAC for data networking. The WiNet protocol uses the MUX sub layer and service defined in the WiMedia MAC specification. The MUX sub layer combined with the WiNet protocol corresponds to the logical link control sub layer of the standard ISO/OSI IEEE 802 reference model. For more information about the WiNet protocol, MUX sub layer and service, and WiMedia MAC specification, see the WiNet specification at www.WiMedia.org.

As with all electronic devices, there is a need to be able to properly test various devices to confirm that they conform to a desired standard. Further, when in operation, it may be necessary to debug or troubleshoot any communication or operational problems that arise. Therefore it would be beneficial to provide an improved method and apparatus that allow for this type of testing to be performed in accordance with this new standard.

### SUMMARY OF THE INVENTION

Therefore, in accordance with the invention, a test and measurement apparatus is provided that provides full protocol decoding from low-level packets to high-level Wire Adapter transfers for Wireless-USB or other protocol devices. It is therefore contemplated that to the extent any other protocol definitions employ similar attributes; the features of the invention would be applicable thereto.

Furthermore, in accordance with a first aspect of the invention, the inventors have recognized that proper spatial positioning of a wireless analyzer relative to wireless devices from which the data is recorded may greatly affect the analyzer's recording quality. Recording quality refers to the data recorded by the analyzer compared to the same data that would have been received by a device in response to the same transmission. Ideally, analyzer and all wireless devices would receive the same data. Practically, this is not the case because of the high bit error rate, channel fading due to short-range communication, multipath effects, and other factors specific to the wireless communications.

This first aspect of the invention provides a method and apparatus that perform wireless analyzer spatial position optimization that maximizes recording quality. Such a wireless analyzer position optimization method and apparatus is applicable to any short-range wireless technology, such as Bluetooth, UltraWideband, and IEEE 802.11. However, this aspect of the invention will be described making reference to an example employing UltraWideband technology.

Following is the list of preferred benefits for the method and apparatus constructed in accordance with the first aspect of the invention:
1) Interoperability: the method and apparatus work with any PHY vendor and any antenna type (directional, omni-directional, or multi-antenna array).
2) The method and apparatus support any network topology defined in any applicable specifications, including worst-case scenarios such as handling hidden terminal phenomenon.
3) The method and apparatus provide support for 2-D (optionally 3-D) spatial positioning optimization.
4) Adaptability: the method and apparatus update the positioning determination in cases of link addition, removal, or any abrupt changes of the existing link conditions (for example device mobility and transmission rate change).
5) Resilience: the method and apparatus provide for various levels of data recovery if some measurements are lost.
6) Computational simplicity: in accordance with the method and apparatus, calculations are performed in real time.
7) Non-intrusive: a wireless analyzer constructed in accordance with the invention does not introduce any overhead traffic in the network.
8) User interface is simple and intuitive.

In accordance with a second aspect of the invention, the inventor has recognized that filtering and triggering on a specific frame pattern match is an important feature in a protocol analyzer. Current pattern matching methods used in, for example, LeCroy/CATC protocol analyzers, and other protocol analyzers available in the marketplace, are limited. For example, currently available protocol analyzers cannot perform flexible pattern matching on frames that contain multiple higher-level packets. However, it is just this type of pattern matching that would be desirable for a WirelessUSB protocol running on top of an UltraWideband MAC, or other similar protocols. Therefore, in accordance with this second aspect of the invention, it would be desirable to provide such a pattern matching method and apparatus that overcomes the drawbacks of the prior art.

Currently, there are two main pattern match FPGA implementations that are employed in LeCroy/CATC protocol analyzers. These comprise 1) a sliding match on a fixed pattern, and 2) matching a fixed pattern at specific offset from the beginning of a frame.

FIG. 2 shows simplified structure of an UltraWideband MAC frame. The frame consists of the following fields: variable length Frame Header, Payload Length, which indicates the length of the entire frame payload, Frame Payload, and CRC. Frame Payload, in turn, may further comprise multiple higher-level packets that belong to a protocol, such as WirelessUSB. FIG. 2 shows N WirelessUSB packets inside a Frame Payload. Each packet is preceded by a Packet Length field, which indicates the length of a next Nth Packet.

It has been determined by the inventor of the present invention that if a user wants to trigger on a specific pattern inside Packet #N, it cannot be achieved using existing implementation. This is because, first, the length of the Frame Header field is variable. Second, the start of Packet #N field depends on the length of previous (N−1) packets inside the frame.

In these two current pattern match implementations—a sliding match on a fixed pattern, and matching a fixed pattern at specific offset from the beginning of a frame—the comparisons made are static. They view a frame as a single “entity”, without looking into individual fields like Length.

In accordance with the invention, the proposed pattern match method is able to make dynamic comparisons, and therefore overcome the drawbacks of the currently-employed methods. The proposed invention is programmable, in that users may write a sequence of instructions to implement a pattern match that utilizes internal frame structure for matching. A specialized instruction set that may handle both frame parsing and pattern matching is also proposed.

In accordance with the invention, the two existing pattern match methods—a sliding match on a fixed pattern, and matching a fixed pattern at specific offset from the beginning of a frame—can be easily implemented using the programmable pattern match method of the invention by specifying a sequence of instructions. Thus, the currently-employed methods may be used in conjunction with the invention described in accordance with the second aspect of the present invention.

In accordance with a third aspect of the invention, the inventor has recognized that devices that utilize distributed networking protocols are often required to comply with specific Quality of Service (QoS) requirements. For example, devices that run TCP/IP stack on top of Bluetooth or UltraWideband, or any devices that allow point-to multipoint type of connections may fall into this group. Examples of such QoS requirements include:
Delay and jitter specifications: It is important to know, or to meet certain limits on the probability that packet delay or jitter does not exceed a certain threshold. This is important for isochronous traffic (audio, video) performance.
Admission control specifications: It is important to know, or to meet certain limits on the probability that bandwidth of a newly requested connection will not exceed an available bandwidth amount. In such a case, typically the bandwidth of both new and existing connections is not static, but characterized by some mean and variance.

To properly test that such devices meet QoS requirements, in accordance with the invention, a traffic generator is provided that is able to inject traffic with specific statistical distributions. Current traffic generation capabilities in LeCroy's Exercisers, as well as other traffic generators in the market, are limited to sending a specific number of packets with predefined length, and therefore are not sufficient in the current, more complex testing environment.

Still other objects and advantages of the invention will in part be obvious and will in part be apparent from the specification and the drawings.

The invention accordingly comprises the features of construction, combination of elements, and arrangement of parts which will be exemplified in the construction hereinafter set forth, and the scope of the invention will be indicated in the claims.

### BRIEF DESCRIPTION OF THE DRAWINGS

For a more complete understanding of the invention, reference is made to the following description and accompanying drawings, in which:

FIG. 1 is a network topology example depicting a first embodiment of the present invention;

FIG. 2 is a block diagram depicting an UltraWideband frame structure used to describe a second embodiment of the present invention;

FIG. 3 is a block diagram depicting a programmable pattern match sequence in accordance with the second embodiment of the invention; and

FIG. 4 is a block diagram depicting an instruction format useful in explaining the second embodiment of the present invention.

### DETAILED DESCRIPTION OF THE PREFERRED EMBODIMENTS

Making reference to the figures, the first embodiment of the invention directed to a wireless analyzer position optimization method and apparatus will now be described.

Mathematical Formulation

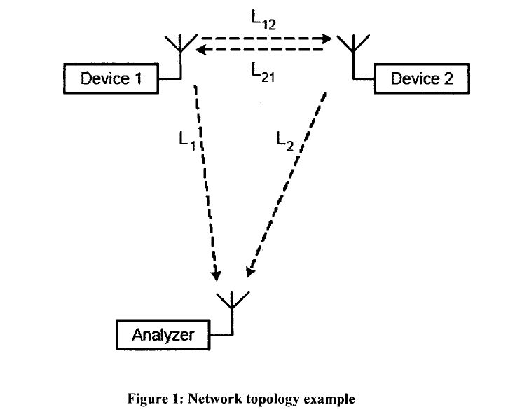

FIG. 1 depicts an example network topology, where a wireless analyzer (Analyzer) records the traffic between two wireless devices (Device 1, Device 2). The objective of the algorithm in accordance with the invention is to find the analyzer position in 2-D space (or perhaps 3-D where applicable) relative to the network of N devices (two devices in the above figure) such that it maximizes an estimator function E, which represents a recording quality metric.

The following notation is used:

(x, y): discrete 2-D coordinates of the analyzer relative to some reference point.

φ: angular direction of the analyzer's antenna relative to some reference axis.

D: set of all possible values of (x, y, φ) in 2-D space

Eᵢ(x, y, φ, k): estimator function that represents recording quality metric of a link at time k.

Lᵢⱼ: directional link from device i to device j. For example, in the figure above, L₁₂ is a link from device 1 to device 2.

Lⱼ: directional link from device i to all devices in the network.

N: total number of devices in the network that a particular analyzer is monitoring.

Pᵢ(k): data disparity

i,jε{1 . . . N}

The algorithm of the invention takes advantage of the following measurements:

1) RSSI: received signal strength indicator. RSSI is calculated in every received packet whether it is corrupted or not.

2) Data disparity: defined as the difference between how a packet is received by the analyzer vs. how it's received by a device. A complete description of data disparity is provided below.

UltraWideband technology provides other useful metrics that may possibly be taken advantage in accordance with the invention, including LQI (link quality indicator) provided in each received packet, and range estimation between devices. However, a preferred embodiment of the invention does not employ these additional metrics for the following reasons:

1) LQI is that it is a vendor-specific estimation of link quality, and therefore unsuitable for generic use.

2) Range estimation is intrusive. It generates traffic overhead on the link. It is optional, and may not be supported by all devices. In some cases it is meaningless, for example when devices are not in line-of-sight.

Data Disparity

Data disparity is defined as the difference between how a packet is received by an analyzer vs. how it's received by a device. It is based on the analysis of (Data-ACK) transfers: for every packet that contains a payload there is an ACK packet sent after SIFS or MIFS interval that acknowledges all packets up to the SequenceNumber value. UltraWideband MAC specification defines the following ACK policies: Immediate-ACK, Block-ACK, and No-ACK. The algorithm of the invention takes advantage of the first two.

Therefore, in accordance with the invention, an analyzer can always determine whether or not a device correctly received specific packet by the means of further retransmission. Note that Beacon frames are not acknowledged. Therefore, to quantify Beacon data disparity, another metric can be used. For example, make use of the periodic transmission of Beacon frames. Data disparity cannot be calculated for each received packet, because not all packets carry sequence number and require ACK. Therefore, data disparity is interpolated from previous values for each estimator calculation.

The following table provides different cases of data disparity values for a packet:

| Analyzer | Device | Data Disparity, Pₖ |
|---|---|---|
| Received packet | Received packet is corrupted | w₁ - positive data |
| correctly | or not received at all | disparity |
| Any header | Received packet correctly | w₂ - negative data |
| error | | disparity |
| Received correct | Received packet correctly | w₃ - negative data |
| header, any | | disparity |
| payload error | | |
| Any header | Received packet is corrupted | Data disparity |
| or payload | or not received at all | is zero |
| error | | |
| Received packet | Received packet correctly | Data disparity is zero |
| correctly | | |

Link estimator function Ei(x, y, φ, k)

Estimator function Ei(x, y, φ, k) for link i is defined (in this particular example) as:

Ei(x, y, φ, k)=Qi(k)+Pi(k), ∀ iε {1 . . . N}
Qi(k+1)=α*Qi(k)+(1−α)*RSSIi: weighted average of RSSI samples for link i
Pi(k+1)=β*Pi(k)+(1−β)*Pi: weighted average of data disparity samples for link i
α,β: scalar weight values. k: non-negative integer value that represents packet reception event.

Link estimator function Ei(x, y, φ, k) may be recalculated for each received packet for each link. Other link estimator functions may be employed based upon particular hardware considerations.

Position estimation vector (x, y, φ, k)

Position estimation vector (x, y, φ, k) is defined (in this particular example) as the solution to the following non-linear equation system:

$$( x , y , ϕ , k ) = \{ \begin{matrix} arg max ( {E}_{i} ) & ∀ i , j ∈ \{ 1 … N \} \\ arg min ( {\sum }_{i , j} {( {E}_{i} - {E}_{j} )}^{2} ) , & {E}_{i} , {E}_{j} \text{:} link estimator functions\end{matrix}$$

The first equation finds a maximum position estimation vector over all links. The second equation finds a position estimation vector corresponding to a minimum difference between all pairs of link estimators Ei using quadratic drift function. The above system represents a constrained optimization problem. It can be solved using any applicable numeric method. The position estimation vector is recalculated for each received packet. Other position estimator functions may be employed based upon particular hardware considerations.

The method in accordance with the invention therefore includes the following phases:

1) Training: initial parameter calibration based on the reference topology measurements. Training is performed once for a specific PHY vendor and antenna.

2) Initial estimation: given network topology, perform estimation for substantially all possible positions (x, y, φ) ε D.

3) Calculate link estimator function Eᵢ(x, y, φ, k) for several samples k. To make it practical, the analyzer can be initially placed at point of perceived center-of-mass of the network. Then it can be moved along several axes crossing that point. For each point, several packets are recorded to calculate Eᵢ(x, y, φ, k).

4) Calculate position estimation vector (x, y, φ, k). Note that there might be several values close to the maximum estimator. Use some heuristic rule to find the best one in the set.

5) After the analyzer is positioned, calculate Eᵢ for each received packet subject to known (x, y, φ) position.

6) Perform periodic position updates. An update is triggered by the following events:
New device is added to the network: Beacon frames with new source address are detected.
Existing device leaves the network: Beacon frames with existing source address are missing for longer than Ttimeout.
Abrupt changes of link condition: estimator's gradient exceeds a threshold:

Δ E(x, y, φ)>δ

Therefore, in accordance with this first embodiment of the invention a method and apparatus are provided that may be implemented in a test equipment or other analyzer hardware to perform wireless analyzer spatial position optimization to maximize recording quality.

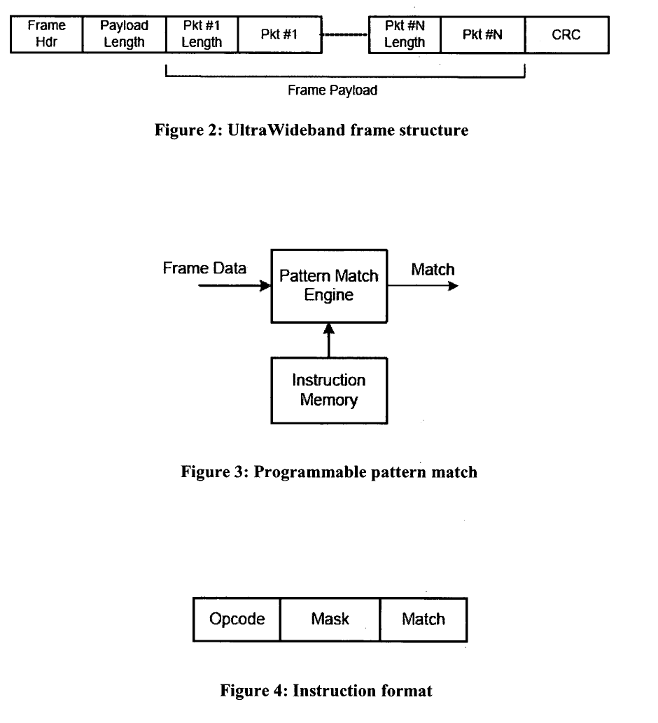

In accordance with a second aspect of the invention, FIG. 3 depicts a programmable pattern match method defined in accordance with the present invention. Such a programmable pattern match engine in accordance with the invention meets the following criteria:
Operates at least at the incoming data speed (substantially real time);
Finds one, multiple, or no matches;
Single-pass parsing: the same protocol data unit need not be used more than once.

Such a pattern match engine uses a specialized instruction set in a format as shown in FIG. 4. The Mask and Match fields shown in FIG. 4 are used in the following way:

(Data & Mask)==(Match & Mask)

The size of Mask and Match fields are 8-bit for UltraWideband.

The Opcode field defines the operation to be performed. Its structure is similar to known existing assembly languages.

In a particular example, a Smallest UltraWideband data unit is 8-bit or an octet. A frame consists of multiple octets, which are received one at a time. For example, an UltraWideband Beacon frame may start with the following sequence of octets (written in hexadecimal notation):

0xA0, 0x0E, 0x80, 0x60, 0x00, 0x00, 0x00, 0x21, 0x43, 0x34, 0x12, 0x1D, 0x09, 0x34, 0x12 [1]

In this particular example, a user may want a protocol analyzer to trigger on the following pattern of the first octet of the frame [1]:

0xAX [2]

Where capital ‘X’ represents a “don't care” value, or a value that does not matter.

To implement such a pattern match, three fields should be used:

Data field to keep track of the incoming frame octets. In the example [1] this Data field includes 0xA0

Mask field to indicate “don't care” bits in [2]. In the example, the Mask is 0xF0.

Match field to indicate the pattern applicable to bits that are not “don't care”. In the example, it's 0xA0.

The following equation that uses bit-wise logical AND on the Data, Mask, and Match to produce the desired result.

(Data & Mask)==(Match & Mask)

Opcode is an abbreviation of Operation Code. Opcode field is the portion of the instruction defined in FIG. 4. Opcode field defines the operation to be performed. Mask and Match fields are parameters to the instruction.

All possible Opcode values are referred to as an Instruction Set. In the context of this invention, this Instruction Set includes all possible Opcodes used to implement programmable pattern matching.

An exact Instruction Set is not particularly defined in this disclosure, because it depends on specific protocol and requirements for pattern matching. In general, the Instruction Set can be flexible enough to allow for the protocol analyzer to match any desired regular expression available in a particular protocol.

It's important to note that the above description is for UltraWideband technology. Other technologies use different data format. For example, smallest USB data unit is 16-bit, and PCI Express' is 32-bit. The proposed method will work with any of these alternative technologies.

In accordance with the invention, the application compiles a user-defined match configuration into an instruction sequence. That instruction sequence is then downloaded to an instruction memory in an FPGA, and executed for each arriving packet. During execution, the packet information is searched to determine if there is a match with the defined instruction sequence. If a match is determined, a user is notified thereof

In accordance with this second aspect of the invention invention, a particular instruction set is defined for each specific protocol and formatting requirements thereof. Therefore, the invention is flexible enough to allow the instruction sequence to search for a match using any regular expression that may be defined in accordance with a particular protocol.

In accordance with a third aspect of the invention, as noted above, devices that utilize distributed networking protocols are often required to comply with specific Quality of Service (QoS) requirements. For example, devices that run TCP/IP stack on top of Bluetooth or UltraWideband, or any devices that allow point-to multipoint type of connections may fall into this group.

To properly test devices, a traffic generator may be employed to inject simulated data into a network in order to determine the reaction of the network to such data. In accordance with the invention, in order to properly test that devices meet QoS requirements, in accordance with this third embodiment of the invention, a traffic generator is provided that with a traffic generation module that is able to inject traffic with specific statistical distributions tailored to testing various desirable parameters. Therefore, in accordance with the invention, in order to support QoS testing, the traffic generator of the invention is able transmit traffic so that the number of sent packets over time has a certain predetermined statistical distribution, the Payload length of packets sent over time has a certain predetermined statistical distribution, and the time between sent packets has a certain predetermined statistical distribution.

These statistical distributions may be selected from any number of statistical distributions. In a preferred embodiment of the invention there are two preferred statistical distributions to model networking traffic. An exponential distribution can be used to model uncorrelated packets while a self-similar distribution may be used for modeling correlated packets that are sent in bursts. Thus, such a system may be beneficial for use with an FPGA, thus avoiding the need for a software algorithm, and may allow for substantially real time operation of the system as a whole. Furthermore, by appropriately selecting these designated, or other parameters and statistical distributions of injected traffic to test any number of desired parameters of a network response.

While the invention has been described applicable to WUSB, the invention is intended to be equally applicable to other protocol definitions and to electronic apparatuses in general.

It will thus be seen that the objects set forth above, among those made apparent from the preceding description, are efficiently attained and, since certain changes may be made in the above construction(s) without departing from the spirit and scope of the invention, it is intended that all matter contained in the above description or shown in the accompanying drawing(s) shall be interpreted as illustrative and not in a limiting sense.

It is also to be understood that the following claims are intended to cover all of the generic and specific features of the invention herein described and all statements of the scope of the invention which, as a matter of language, might be said to fall there between.

What is claimed:

1. A method for performing wireless analyzer spatial position optimization for a network having a particular network topology, comprising the steps of:
recording one or more reference network topology measurements to perform an initial parameter calibration;
estimating a plurality of possible relative positions for the particular network topology;
calculating a link estimator function for each link between a plurality of the possible relative positions; and
calculating recording quality for each received packet at each of the plurality of possible relative positions over each of the links;
whereby a position indicative of an optimal position is determined.

2. The method of claim 1, further comprising the steps of:
determining that the particular network topology has changed; and
automatically performing the steps of claim 1 in accordance with the changed network topology.

3. The method of claim 2, wherein the network topology changes when a new device is added to the network.

4. The method of claim 2, wherein the network topology changes when a device is removed from the network.

5. The method of claim 2, wherein the network topology changes when the link estimator function of one of the plurality of positions changes.

6. The method of claim 1, wherein the plurality of positions are in a substantially two dimensional plane.

7. The method of claim 1, wherein the plurality of positions are in a substantially three dimensional space.

8. The method of claim 1, whereby recording quality is optimized at the optimal position.

9. A method for determining a pattern match between a designated pattern and data in a data sequence of data received in a protocol analyzer, comprising the steps of:
designating a portion of a pattern to be matched as bits that can take on any value;
designating bit values of a portion of the pattern to be matched;
performing a bitwise logical comparison between the pattern to be matched, including the designated bit values and bits that can take on any value, and the data sequence in substantially real time; and
indicating a location in the data stream of any determined matches.

10. The method of claim 9, wherein the designated portions of the pattern are constructed into an instruction sequence.

11. The method of claim 10, wherein the instruction sequence is implemented in a Field Programmable Gate Array (FPGA).

12. The method of claim 11, wherein the instruction sequence comprises the pattern to be matched, including the designated bit values and bits that can take on any value.

13. The method of claim 12, wherein a user is notified in substantially real time when a match is determined.

14. A system for generating traffic for testing a network, comprising:
a traffic generation module for generating traffic to be injected into a network;
wherein one or more parameters of the traffic conforms to a predetermined statistical distribution.

15. The system of claim 14, wherein the he number of sent packets over time conforms to the predetermined statistical distribution.

16. The system of claim 14, wherein the Payload length of packets sent over time conforms to the predetermined statistical distribution

17. The system of claim 14, wherein the time between sent packets conforms to the predetermined statistical distribution.

18. The system of claim 14, wherein the predetermined statistical distribution is an exponential distribution used to model uncorrelated packets.

19. The system of claim 14, wherein the predetermined statistical distribution is a self-similar distribution used to model correlated packets that are sent in bursts.
